(19) United States
(12) Patent Application Publication
(10) Pub. No.: US 2003/0055843 A1
(43) Pub. Date: Mar. 20, 2003

(54) Server system and method for providing online multi-dimensional production data report

(75) Inventor: Hung-Liang Chiu, Taipei (TW)

Correspondence Address: Mr. Peter F. Corless, EDWARDS & ANGELL, LLP, 101 Federal Street, Boston, MA, 02110, US

(73) Assignee: Inventec Corporation, Taiwan (CN)

(21) Appl. No.: 10/157,945

(22) Filed: May 29, 2002

(30) Foreign Application Priority Data
Sep. 6, 2001 (TW) 90122054

(51) Int. Cl. G06F 17/00; G06F 7/00; G06F 17/60

(52) U.S. Cl. 707/104.1; 705/1

(57) ABSTRACT

A server system and method is proposed for providing online multidimensional production data report, which allows a production manager to view production-related data, including procurement data, purchase order data, stock data, shipment data, and so on, in a multidimensional format via a network system, such as the Internet. The proposed server system and method is characterized by the use of an SQL (Structured Query Language) server and OLAP (On-Line Analytical Processing) service to process production data in a multidimensional format to create a multi-dimensional production data report, and by the use of a Web server for online access to the multidimensional production data report. This allows a production manager to gain access to the multidimensional production data report by using an Internet-connected computer unit to link to the Web server, and multidimensionally view and analyze the production data via Internet using a spreadsheet program or a Web browser program.

### BACKGROUND OF THE INVENTION

1. Field of the Invention

This invention relates to information technology, and more particularly, to a server system and method for providing online multidimensional production data report, which allows a production manager to view production-related data, including procurement data, purchase order data, stock data, shipment data, and so on, in a multidimensional format via a network system, such as the Internet.

2. Description of Related Art

At a factory, production management decisions rely on the analysis on production-related data, including procurement data, purchase order data, stock data, shipment data, and so on. These production data are typically extremely complex and large in amount; and therefore, it is required to prepare and compile these production data in a predefined format to create a production data report that is easy for the production manager to read and analyze data.

Conventionally, however, the preparation and compilation of these complex and large amounts of production data are performed by human, and therefore is quite laborious, time-consuming, and error-prone, making the overall production management quite inefficient. Moreover, conventional production data reports are usually complied in a fixed format, i.e., a two-dimensional row and column format, that would make the production manager difficult to multidimensionally group and summarize relevant data in the production data report.

### SUMMARY OF THE INVENTION

It is therefore an objective of this invention to provide a server system and method that can prepare and compile production data automatically without involving human workforce, so as to make the overall production management more reliable and efficient.

It is another objective of this invention to provide a server system and method that can provide an online multidimensional production data report in real time to the production manager, so as to allow the production management to be more efficient.

It is still another objective of this invention to provide a server system and method that can provide a production data report in multidimensional format, so as to allow the production manager to multidimensionally view and analyze the production data.

The server system and method according to the invention is designed for providing an online multidimensional production data report, and which is characterized by the use of an SQL (Structured Query Language) server and OLAP (On-Line Analytical Processing) service to convert and process production data in a multidimensional format, and by the use of a Web server for online access to the multidimensional production data report. This allows a production manager to gain access to the multidimensional production data report by using an Internet-connected computer unit to link to the Web server, and then multidimensionally view and analyze the production data via Internet using a spreadsheet program, such as Microsoft Excel's Pivot Table, or a Web browser program, such as Microsoft Internet Explorer or Netscape Navigator.

Compared to the prior art, the invention allows the production manager to view the production data in multidimensional format, rather than two-dimensional row and column format as in the case of the prior art, so that the production manager can easily group and summarize relevant data in the production data report to make important management decisions more efficiently, reliably, and optimally.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the basic system architecture of the server system according to the invention for providing online multidimensional production data report;

FIG. 2 is a flow diagram showing the procedural steps carried out by the server system according to the invention for providing online multidimensional production data report;

FIGS. 3A-3C show an example of an online multidimensional production data report generated by the server system and method according to the invention when displayed through Microsoft Internet Explorer.

### DETAILED DESCRIPTION OF PREFERRED EMBODIMENTS

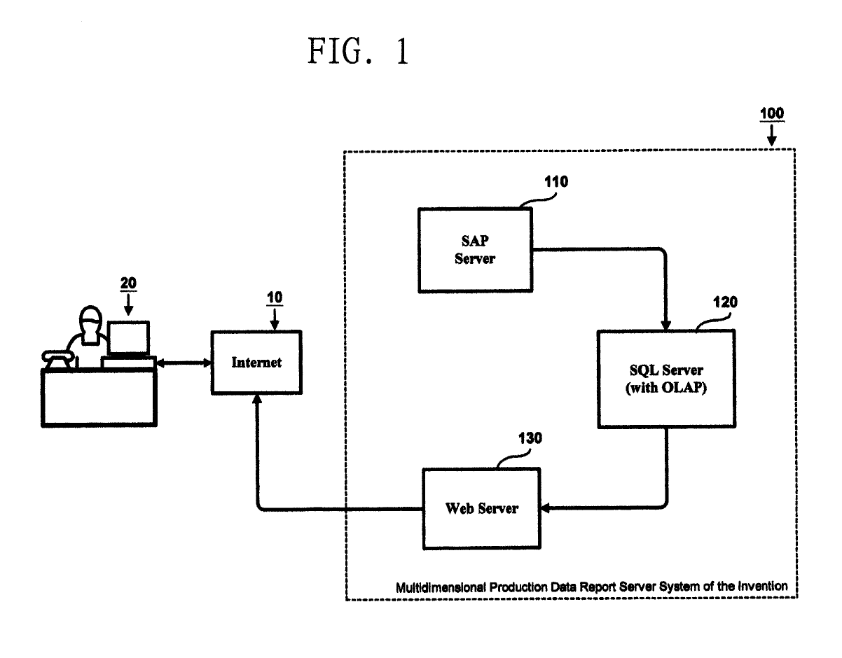

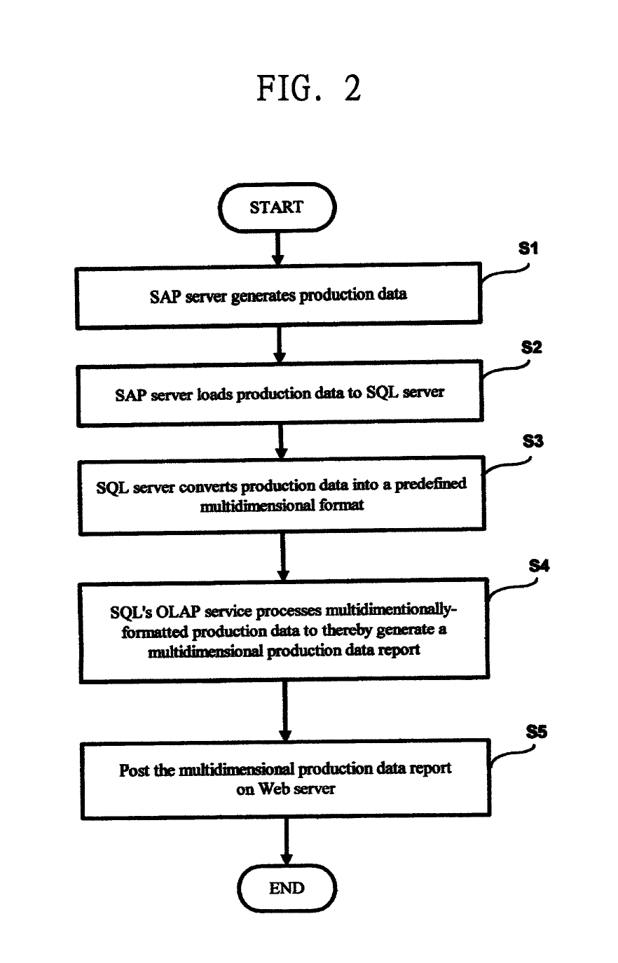

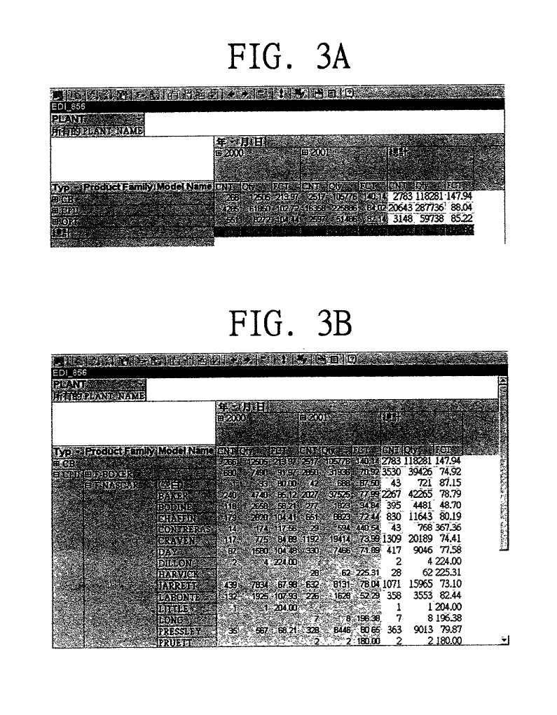

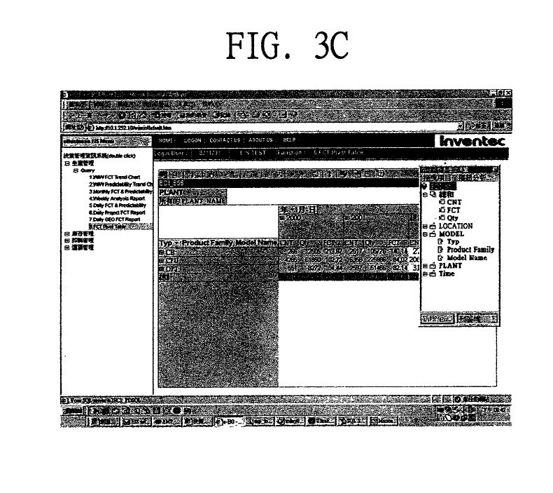

The server system and method for providing online multidimensional production data report according to the invention is disclosed in full details in the following with reference to FIG. 1, FIG. 2, and FIGS. 3A-3C.

Referring first to FIG. 1, the server system according to the invention (indicated by the reference numeral 100) is designed to provide an online multidimensional production data report, and which is externally linked to a net-work system, such as the Internet 10, so as to allow any production management staff to use an Internet-connected computer unit 20 to gain access to the server system 100 of the invention and view the online multidimensional production data report.

The server system 100 according to the invention for providing online multidimensional production data report comprises: (a) a SAP server 110; (b) a SQL server 120; and (c) a network server, such as a Web server 130.

The SAP server 110 is based on the SAP (Service Advertising Protocol) standard and is used to generate a set of production data related to a particular production project, including, for example, procurement data, purchase order data, stock data, shipment data, and so on. Since the SAP standard is well known in the information industry, description thereof will not be detailed in this specification.

The SQL server 120 is a database server based on the SQL (Structured Query Language) standard, and which is linked to the SAP server 110 to receive the production data therefrom. The SQL server 120 can be, for example, the Microsoft SQL Server, which includes a multidimensional data formatting capability which can be used to gather the production data in a multidimensional format, called cube. Moreover, the SQL server 120 further includes an OLAP (On-Line Analytical Processing) service which can be used to process the multidimensionally-formatted production data in the cube to thereby create a multidimensional production data report. Since the SQL standard is well known in the information industry, description thereof will not be further detailed.

The Web server 130 is externally linked to the Internet 10 and internally linked to the SQL server 120, which allows the SQL server 120 to post its prepared multidimensional production data report on the Web server 130, so as to allow authorized personnel to gain access to the multidimensional production data report via the Internet 10. When linked via the Internet 10 to the Web server 130, the production manager can view the multidimensional production data report by using a spreadsheet program, such as Microsoft Excer's Pivot Table, or a Web browser program, such as Microsoft Internet Explorer or Netscape Navigator.

FIG. 2 is a flow diagram showing the procedural steps carried out by the server system 100 according to the invention for providing an on-line multidimensional production data report.

Referring to FIG. 2 together with FIG. 1, in the first step S1, the SAP server 110 is used to generate a set of production data related to a particular production project. These production data include, for example, procurement data, purchase order data, stock data, shipment data, and so on.

In the next step S2, the SAP server 110 downloads the production data to the SQL server 120.

In the next step S3, the SQL server 120 utilizes its multidimensional data formatting capability to define a predefined multidimensional format based on a predefined dimensional order for formatting the production data in multidimensional format.

In the next step S4, the SQL server 120 utilizes its OLAP service to process the multidimensionally-formatted production data to thereby create a multidimensional production data report.

In the next step S5, the multidimensional production data report is prepared as a Web page and posted on the Web server 130 for online access. This allows the production manager to gain access to the multidimensional production data report by using an Internet-connected computer unit 20 to link to the Web server 130. When linked, the production manager can view the multidimensional production data report by using a spreadsheet program, such as Microsoft Excel's Pivot Table, or a Web browser program, such as Microsoft Internet Explorer or Netscape Navigator, and perform multidimensional analysis on the displayed data. Since the production data are prepared and complied in multidimensional format, it allows the production manager to multidimensionally group and summarize relevant data in the production data report, making the production management more efficient and optimized.

FIGS. 3A-3C show an example of an online multidimensional production data report generated by the server system and method according to the invention; wherein FIG. 3A shows an example of an online multidimensional production data report generated by the server system and method of the invention when displayed in unexpanded mode through Microsoft Internet Explorer; FIG. 3B shows the same of FIG. 3A except when displayed in expanded mode; and FIG. 3C shows the same of FIG. 3A and FIG. 3B except when performing a multidimensional analysis on the displayed data.

In conclusion, the invention provides a novel server system and method for providing online multidimensional production data report, which is characterized by the use of an SQL server and OLAP service to convert and process production data in a multidimensional format, and by the use of a Web server for online access to the multidimensional production data report. This allows the production manager to gain access to the multidimensional production data report by using an Internet-connected computer unit to link to the Web server, and multidimensionally view and analyze the production data via Internet using a spreadsheet program, such as Microsoft Excel, or a Web browser program, such as Microsoft Internet Explorer or Netscape Navigator.

Compared to the prior art, the invention allows the production manager to view the production data in multidimensional format, rather than two-dimensional row and column format as in the case of the prior art, so that the production manager can easily group and summarize relevant data in the production data report to make important management decisions more efficiently, reliably, and optimally. The invention is therefore more convenient and efficient to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for providing online multi-dimensional production data report, comprising the steps of:
(1) generating a set of production data;
(2) loading the production data to a SQL server having an OLAP service;
(3) in the SQL server, converting the production data in a predefined multidimensional format based on a predefined dimensional order;
(4) in the SQL server, using the OLAP service to process the multidimensionally-formatted production data to thereby create a multidimensional production data report; and
(5) posting the multidimensional production data report on a network server linked to a network system for online access to the multidimensional production data report via the network system.

2. The method of claim 1, wherein in said step (1), a SAP server is used to generate the production data.

3. The method of claim 1, wherein in said step (5), the network system is Internet.

4. The method of claim 3, wherein in said step (5), the network server is a Web server.

5. The method of claim 3, wherein in said step (5), Microsoft Internet Explorer is used to view the multidimensional production data report.

6. The method of claim 3, wherein in said step (5), Netscape Navigator is used to view the multidimensional production data report.

7. The method of claim 1, wherein in said step (5), Microsoft Excel is used to view the multidimensional production data report.

8. A method for providing online multi-dimensional production data report, comprising the steps of
(1) using a SAP server to generate a set of production data;
(2) loading the production data to a SQL server having an OLAP service;
(3) in the SQL server, converting the production data in a predefined multidimensional format based on a predefined dimensional order;
(4) in the SQL server, using the OLAP service to process the multidimensionally-formatted production data to thereby create a multidimensional production data report; and
(5) posting the multidimensional production data report on a Web server linked to Internet for online access to the multidimensional production data report via Internet.

9. The method of claim 8, wherein in said step (5), Microsoft Internet Explorer is used to view the multidimensional production data report.

10. The method of claim 8, wherein in said step (5), Netscape Navigator is used to view the multidimensional production data report.

11. The method of claim 8, wherein in said step (5), Microsoft Excel is used to view the multidimensional production data report.

12. A server system for providing online multidimensional production data report, comprising:
(a) a SAP server, which is used to generate a set of production data;
(b) a SQL server, which is used to receive the production data from the SAP server, and which is used to convert the production data in a predefined multidimensional format based on a predefined dimensional order, and further utilize an OLAP service to process the multidimensionally-formatted production data to thereby create a multidimensional production data report; and
(c) a network server, which is internally linked to the SQL server and externally linked to a network system, and which allows the SQL server to post the multidimensional production data report thereon for online access to the multidimensional production data report via the network system.

13. The server system of claim 12, wherein the network system is Internet.

14. The server system of claim 13, wherein the network server is a Web server.
